(19) United States
(12) Patent Application Publication
(10) Pub. No.: US 2022/0348216 A1
(43) Pub. Date: Nov. 3, 2022

(54) PROXY BASIC SAFETY MESSAGE FOR UNEQUIPPED VEHICLES

(71) Applicants: DENSO CORPORATION, Kariya (JP); DENSO International America, Inc., Southfield, MI (US)

(72) Inventor: Bryan WELLS, Oceanside, CA (US)

(21) Appl. No.: 17/237,089

(22) Filed: Apr. 29, 2021

(51) Int. Cl. B60W 50/14; H04L 29/08; G07C 5/00; H04W 4/40

(52) U.S. Cl. CPC B60W 50/14; H04L 67/12; G07C 5/008; H04W 4/40; B60W 2050/146

(57) ABSTRACT

A method for generating a message including vehicle operating parameters. The method includes the following: measuring operating parameters of an unequipped vehicle using monitoring equipment present on an equipped vehicle that is proximate to the unequipped vehicle; generating at the equipped vehicle a message including the measured operating parameters of the unequipped vehicle; and transmitting from the equipped vehicle to surrounding vehicles the message including the measured operating parameters of the unequipped vehicle to inform surrounding vehicles of the operating parameters of the unequipped vehicle.

### BACKGROUND

The present disclosure relates to generating a proxy basic safety message for unequipped vehicles.

This section provides background information related to the present disclosure, which is not necessarily prior art.

Active safety systems identify potential threats and hazards on a roadway and provide drivers with associated alerts and warnings. For example, an active safety system is based on vehicle-to-vehicle and vehicle-to-infrastructure wireless communications, such as dedicated short range communication (DSRC). For example, another active safety system is based on vehicle-to-everything communications, such as cellular vehicle-to everything communication (C-V2X). To maximize the benefits of such active safety systems, wireless communication equipment would have to be installed in all vehicles and relevant pieces of roadside communication systems such as infrastructure or pedestrian devices, which will take many years to achieve, and may never be fully achieved. An alternative active safety system in which less than all vehicles and pieces of infrastructure are equipped with DSRC or C-V2X would therefore be desirable.

### SUMMARY

This section provides a general summary of the disclosure, and is not a comprehensive disclosure of its full scope or all of its features.

The present teachings include a method for generating a message including vehicle operating parameters. The method includes the following: measuring operating parameters of an unequipped vehicle using monitoring equipment present on an equipped vehicle that is proximate to the unequipped vehicle; generating at the equipped vehicle a message including the measured operating parameters of the unequipped vehicle; and transmitting from the equipped vehicle to surrounding vehicles the message including the measured operating parameters of the unequipped vehicle to inform surrounding vehicles of the operating parameters of the unequipped vehicle.

The present teachings further include a method for generating one or more proxy messages including vehicle operating parameters. The method includes receiving at a primary equipped vehicle messages from secondary equipped vehicles, the messages identifying positions of each one of the secondary equipped vehicles; comparing the positions of the secondary equipped vehicles with positions of unequipped vehicles detected by the primary equipped vehicle for which no messages have been received; generating at the primary equipped vehicle a proxy message for each one of the unequipped vehicles including operating parameters of the unequipped vehicles; and transmitting from the primary equipped vehicle to the secondary equipped vehicles the proxy messages generated for each one of the unequipped vehicles to inform the secondary equipped vehicles of the operating parameters of the unequipped vehicles.

The present teachings also include a method for generating at least one proxy basic safety message (PBSM) having vehicle operating parameters. The method includes the following: identifying locations of secondary vehicles proximate to a primary vehicle using identification equipment of the primary vehicle; comparing positions of the secondary vehicles identified by the primary vehicle to vehicle positions set forth in basic safety messages (BSMs) received by the primary vehicle; designating as secondary equipped vehicles the secondary vehicles identified by the primary vehicle having positions that match the vehicle positions set forth in the BSMs received by the primary vehicle; designation as secondary unequipped vehicles the secondary vehicles identified by the primary vehicle having positions that do not match the vehicle positions set forth in the BSMs received by the primary vehicle; generating at the primary vehicle the PBSM for each one of the secondary unequipped vehicles including operating parameters of the unequipped vehicles; and transmitting from the primary vehicle to the secondary equipped vehicles the PBSMs to inform the secondary equipped vehicles of the operating parameters of the secondary unequipped vehicles.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates a method and system according to the present teachings for generating one or more messages including vehicle operating parameters according to the present teachings for vehicles not equipped with an active safety system.

Corresponding reference numerals indicate corresponding parts throughout the several views of the drawings.

### DETAILED DESCRIPTION

Example embodiments will now be described more fully with reference to the accompanying drawings.

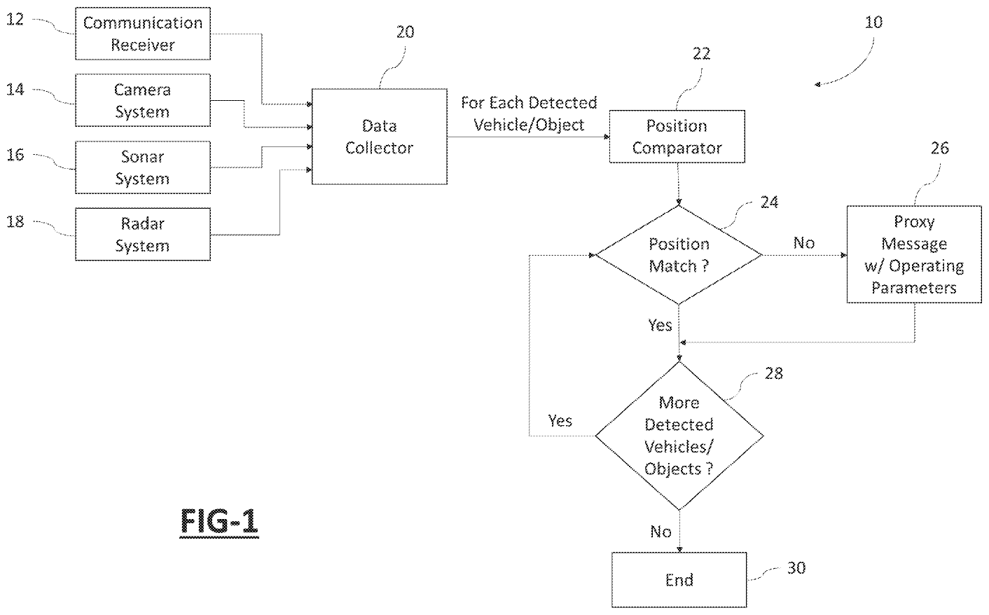

With reference to FIG. 1, a method and system according to the present teachings for generating a proxy message including vehicle operating parameters for a vehicle not equipped with an active safety system, such as dedicated short range communication (DSRC) or cellular vehicle-to-everything communication (C-V2X), is generally illustrated at reference numeral 10. For purpose of explanation only, the method and system based on C-V2X will be described hereafter, however it should be understood that the method and system may be based on DSRC.

A communication receiver of a primary C-V2X equipped vehicle is illustrated at reference numeral 12. The communication receiver 12 is configured to receive basic safety messages (BSMs) from surrounding C-V2X equipped vehicles proximate to the primary C-V2X equipped vehicle. The BSMs can include information regarding any suitable operating parameter of the surrounding C-V2X equipped vehicles, such as one or more of the following operating parameters of each one of the surrounding C-V2X equipped vehicles for example: GPS position data; acceleration; speed; change in speed; throttle percentage; steering angle; and any other suitable operating parameter.

The primary C-V2X equipped vehicle further includes any suitable equipment for detecting the positions of surrounding vehicles and/or objects proximate to the primary C-V2X equipped vehicle. For example, the primary C-V2X equipped vehicle may include on board detection systems or devices, such as a camera system 14, a sonar system 16, a radar system 18, or any other detecting device for detecting the surrounding vehicles and/or objects.

Data from the communication receiver 12, the camera system 14, the sonar system 16, the radar system 18, and any other detecting device is input to a data collector 20. The data collector 20 can be any suitable processing device, such as a central processing unit (CPU). The data collected for each vehicle and/or object by the data collector 20 is input to a position comparator 22. The position comparator 22 may be any suitable device configured to compare data collected by the data collector 20, such as a CPU. The position comparator 22 may be separate from the data collector 20 or included with the data collector 20. For example, the CPU of the position comparator 22 may be separate from, or the same as, the CPU of the data collector 20.

The method will be described hereafter in greater detail.

The data collector 20 is configured to obtain location information (i.e., BSM location information) of a secondary C-V2X equipped vehicle transmitted to the communication receiver 12. The data collector 20 is further configured to obtain location information of a surrounding vehicle and/or object using the on board systems or devices, such as the camera system 14, the sonar system 16, the radar system 18, and another detecting device.

Hereafter, an example of the method of the present application comparing a position of the secondary C-V2X equipped vehicle with a position of a surrounding vehicle detected by the on board systems or devices will be described. However, it should be understood that the method may compare the position of the secondary C-V2X equipped vehicle with a position of any objects, such as a pedestrian device.

At block 24, the position comparator 22 compares the position of the surrounding vehicle with the position of the secondary C-V2X equipped vehicle, based on the BSM location information transmitted from the secondary C-V2X equipped vehicle and the location information of the surrounding vehicle detected by the on board systems or devices.

If at block 24 the position comparator 22 identifies a match, i.e., determines that the position of the surrounding vehicle matches with the position of the secondary C-V2X equipped vehicle, it can be concluded that the surrounding vehicle is the secondary C-V2X equipped vehicle. In other words, it can be concluded that there is no C-V2X unequipped vehicle. As such, the method advances to block 28 to determine whether there is another location information available for comparison, i.e., whether there is another surrounding vehicle detected.

If at block 28 the position comparator 22 identifies the additional location information, the method advances to block 24 so that the position comparator 22 determines whether the position of the other surrounding vehicle matches with the position of the secondary C-V2X equipped vehicle.

The method repeats the process of block 24 and block 28 until no additional vehicle or object is detected at block 28. The operation ends at block 30 when the position comparator 22 identifies no additional location information available for comparison.

If at block 24 the position comparator 22 determines that the position of the surrounding vehicle does not match with the position of the secondary C-V2X equipped vehicle, it means that the primary C-V2X equipped vehicle has detected a vehicle for which no BSM data has been received. In other words, the surrounding vehicle may be a C-V2X unequipped vehicle which is not equipped with C-V2X system. As such, at block 26, the primary C-V2X equipped vehicle generates a proxy BSM for the C-V2X unequipped vehicle.

The proxy BSM includes any suitable vehicle operating parameter information, such as GPS position data, speed, change in speed, acceleration, etc. The vehicle operating parameter information is measured relative to the position of the primary C-V2X equipped vehicle because the parameters are measured by the primary C-V2X equipped vehicle, such as by using one or more of the camera system 14, the sonar system 16, and the radar system 18.

The primary C-V2X equipped vehicle transmits, i.e., broadcasts, the proxy BSM for the C-V2X unequipped vehicle so that other C-V2X equipped vehicles within a specified range can receive the proxy BSM. For example, the proxy BSM is transmitted to the surrounding C-V2X equipped vehicles for which the primary C-V2X equipped vehicle received BSMs for at the communication receiver 12. In this manner, all C-V2X equipped vehicles in the vicinity of the C-V2X unequipped vehicle or vehicles will be aware of the position and operating parameters of the unequipped vehicle or vehicles, and thus be able to avoid the unequipped vehicles and continuously monitor their location or any other suitable parameter.

As mentioned above, the Proxy BSM can also be generated for objects, and can include any suitable information for the objects, such as location and type for example.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for generating a message including vehicle operating parameters comprising:
measuring operating parameters of an unequipped vehicle using monitoring equipment present on an equipped vehicle that is proximate to the unequipped vehicle;
generating at the equipped vehicle a message including the measured operating parameters of the unequipped vehicle; and
transmitting from the equipped vehicle to surrounding vehicles the message including the measured operating parameters of the unequipped vehicle to inform surrounding vehicles of the operating parameters of the unequipped vehicle.

2. The method of claim 1, wherein:
the message is a basic safety message (BSM);
the equipped vehicle and the surrounding vehicles are equipped with cellular vehicle-to everything communications (C-V2X) operable to send and receive BSMs; and
the unequipped vehicle is not equipped with functioning C-V2X.

3. The method of claim 1, further comprising measuring the operating parameters of the unequipped vehicle relative to the equipped vehicle.

4. The method of claim 1, further comprising measuring at least one of the following operating parameters of the unequipped vehicle relative to the equipped vehicle: location;
acceleration; change in speed; speed increase; speed decrease; directional heading; or change in directional heading.

5. The method of claim 1, further comprising measuring operating parameters of the unequipped vehicle using at least one of radar and sonar present on the equipped vehicle.

6. The method of claim 1, further comprising measuring operating parameters of the unequipped vehicle using 360° radar present on the equipped vehicle.

7. The method of claim 1, further comprising measuring operating parameters of the unequipped vehicle using a camera present on the equipped vehicle.

8. The method of claim 1, further comprising transmitting from the equipped vehicle the measured operating parameters of the unequipped vehicle using cellular vehicle-to-everything communications (C-V2X).

9. The method of claim 1, further comprising transmitting from the equipped vehicle the measured operating parameters of the unequipped vehicle as a basic safety message (BSM) using cellular vehicle-to-everything communications (C-V2X).

10. The method of claim 1, further comprising transmitting from the equipped vehicle a basic safety message including vehicle operating parameters of the equipped vehicle including at least one of the following: GPS coordinates; speed; or acceleration.

11. A method for generating one or more proxy messages including vehicle operating parameters comprising:
receiving at a primary equipped vehicle messages from secondary equipped vehicles, the messages identifying positions of each one of the secondary equipped vehicles;
comparing the positions of the secondary equipped vehicles with positions of unequipped vehicles detected by the primary equipped vehicle for which no messages have been received;
generating at the primary equipped vehicle a proxy message for each one of the unequipped vehicles including operating parameters of the unequipped vehicles; and
transmitting from the primary equipped vehicle to the secondary equipped vehicles the proxy messages generated for each one of the unequipped vehicles to inform the secondary equipped vehicles of the operating parameters of the unequipped vehicles.

12. The method of claim 11, further comprising measuring the operating parameters of each one of the unequipped vehicles relative to the primary equipped vehicle.

13. The method of claim 11, further comprising measuring at least one of the following operating parameters of the unequipped vehicles relative to the equipped vehicle: location; acceleration; change in speed; speed increase; speed decrease; directional heading; or change in directional heading.

14. The method of claim 11, further comprising measuring operating parameters of the unequipped vehicles using monitoring equipment present on the equipped vehicle including at least one of radar and sonar.

15. The method of claim 11, further comprising receiving at the primary equipped vehicle the messages from the secondary equipped vehicles in the form of basic safety messages (BSMs); and
transmitting from the primary equipped vehicle to the secondary equipped vehicles the proxy messages in the form of BSMs.

16. The method of claim 15, further comprising transmitting the BSMs using cellular vehicle-to-everything communications (C-V2X).

17. A method for generating at least one proxy basic safety message (PBSM) including vehicle operating parameters comprising:
identifying locations of secondary vehicles proximate to a primary vehicle using identification equipment of the primary vehicle;
comparing positions of the secondary vehicles identified by the primary vehicle to vehicle positions set forth in basic safety messages (BSMs) received by the primary vehicle;
designating as secondary equipped vehicles the secondary vehicles identified by the primary vehicle having positions that match the vehicle positions set forth in the BSMs received by the primary vehicle;
designation as secondary unequipped vehicles the secondary vehicles identified by the primary vehicle having positions that do not match the vehicle positions set forth in the BSMs received by the primary vehicle;
generating at the primary vehicle the PBSM for each one of the secondary unequipped vehicles including operating parameters of the unequipped vehicles; and
transmitting from the primary vehicle to the secondary equipped vehicles the PBSMs to inform the secondary equipped vehicles of the operating parameters of the secondary unequipped vehicles.

18. The method of claim 17, further comprising transmitting the BSMs and PBSMs using cellular vehicle-to-everything communications (C-V2X).

19. The method of claim 17, further comprising identifying locations of the secondary vehicles proximate to the primary vehicle using at least one of radar and sonar.

20. The method of claim 17, wherein the vehicle operating parameters include at least one of the following: location; acceleration; change in speed; speed increase; speed decrease; directional heading; or change in directional heading.
